(19) United States
(12) Patent Application Publication
(10) Pub. No.: US 2010/0189602 A1
(43) Pub. Date: Jul. 29, 2010

(54) SEPARATION DEVICE WITH MOVEABLE FILLING CHANNEL

(75) Inventors: Martin Baeuerle, Waldbronn (DE); Stefan Falk-Jordan, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/693,903

(22) Filed: Jan. 26, 2010

(30) Foreign Application Priority Data
Jan. 26, 2009 (EP) PCT/EP2009/050836

(51) Int. Cl. G01N 30/02; B01D 15/08; B01D 15/22; G01N 30/56

(52) U.S. Cl. 422/70; 210/198.2; 210/281; 210/234; 422/101; 204/601; 210/251

(57) ABSTRACT

A separation device includes a separation chamber having a housing for housing a stationary phase configured for separating compounds of a fluid sample. The separation device also includes a filling port configured for filling the stationary phase through a filling channel into the separation chamber, and a locking piece comprising the filling channel. The locking piece is configured to move the filling channel from a first position, wherein an opening of the filling channel is opening into the separation chamber for filling the stationary phase into the separation chamber, to a second position, wherein the separation chamber is locked against the filling channel. The locking piece is configured to move the opening of the filling channel substantially laterally with respect to the housing.

This application claims priority from International Application No. PCT/2009/050836, filed on 26 Jan. 2009, which is incorporated by reference in its entirety.

### BACKGROUND

The presently disclosed embodiments relate to a separation device, in particular in a high performance liquid chromatography application.

In high performance liquid chromatography (HPLC), a liquid has to be provided usually at a very controlled flow rate (e.g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase (for example a solvent) comprising a sample fluid (e.g. a chemical or biological mixture) with compounds to be separated is driven through a separation device (such as a chromatographic column) comprising a stationary phase, thus separating different compounds of the sample fluid which may then be identified.

As the sample passes with the mobile phase through the stationary phase, the different compounds, each one having a different affinity for the stationary phase (e.g. the packing medium), move through the column at different speeds. Those compounds having greater affinity for the stationary phase move more slowly through the column than those having less affinity, and this speed differential results in the compounds being separated from one another as they pass through the column. The column and its separation characteristic are usually configured to the sample. The term compound, as used herein, shall cover compounds which might comprise one or more different components. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high pressure occurs across the column.

The mobile phase with the separated compounds exits the column and passes through a detector, which identifies the molecules, for example by spectrophotometric absorbance measurements. A two-dimensional plot of the detector measurements against elution time or volume, known as a chromatogram, may be made, and e.g. from the chromatogram the compounds may be identified. For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, are undesirable as they may allow minor components of the mixture to be masked by major components and go unidentified.

An HPLC column typically comprises a stainless steel tube having a bore containing a packing medium comprising, for example, silane derivatized silica spheres having a diameter between 0.5 to 50 μm, or 1-10 μm or even 1-7 μm. The medium is packed under pressure in highly uniform layers which ensure a uniform flow of the transport liquid and the sample through the column to promote effective separation of the sample constituents. The packing medium is contained within the bore by porous plugs, known as “frits”, positioned at opposite ends of the tube. The porous frits allow the transport liquid and the chemical sample to pass while retaining the packing medium within the bore. After being filled, the column may be coupled or connected to other elements (like a control unit, a pump, containers including samples to be analyzed) by e.g. using fitting elements. Such fitting elements may contain porous parts such as screens or frit elements.

Further details about columns are described e.g. in US 2007221557 A1.

Various processes for filling (often also referred to as packing) columns are disclosed e.g. U.S. Pat. No. 4,483,773 A, U.S. Pat. No. 4,549,584 A, U.S. Pat. No. 4,578,193 A, U.S. Pat. No. 6,444,150 B1, or JP 2007298455, or US 2007181501 A1.

In US 2008/0217248 A1 the column is filled via a valve comprising a central bore and a nozzle. After introduction of the desired amount of stationary phase, the valve and nozzle are closed, thus maintaining pressure applied to the packing during filling.

In U.S. Pat. No. 5,714,074 A (corresponding to EP 0696223 B1), the column is filled through an inlet element which is displaceable axially in relation to the column. Pressure applied to the packing during filling is maintained by displacing the inlet element towards the column after completion of the filling.

GB 2440244 A discloses an axial flow chromatography column comprising opposed, axially spaced first and second end units. The first end unit comprises a first port for introducing mobile phase and a transverse fluid distribution channel for distributing fluid uniformly throughout the packed bed. The first port further comprises a valve means used for the introduction of slurry to the bed space. The valve means has a nozzle, which can be lowered into bed space in order that the bed space can be filled with particulate medium in the form of a slurry. The nozzle will be retracted into the body of the longitudinal member once the column has been packed with the particulate medium and prior to any chromatographic separation on the column. After filling and retraction of the nozzle, however, a void volume remains in the packed bed space, which may then lead to chromatographic peak dispersion.

### SUMMARY

It is an object of the disclosed embodiments to provide an improved filling/packing of separation devices, which allows maintaining filling pressure after completion of the filling process and which reduces formation of void volumes caused by the filling/packing of the separation device. The object is solved by the independent claim(s). Further embodiments are shown by the dependent claim(s).

According to the presently disclosed embodiments, a separation device is provided having a separation chamber comprising a housing for housing a stationary phase configured for separating compounds of a fluid sample. The separation device comprises a filling port configured for filling the stationary phase through a filling channel into the separation chamber. The filling port further comprises a locking piece comprising the filing channel and being configured to move the filling channel from a first position to a second position. In the first position, an opening of the filing channel is opening into the separation chamber for filling the stationary phase into the separation chamber. In the second position, the separation chamber is locked against the filling channel. The locking piece is configured to move the opening of the filling channel substantially laterally with respect to the housing.

The locking piece allows to selectively either coupling the filing channel to the separation chamber for filling the separation chamber, and—e.g. after filling—locking the separation chamber against the filling channel. While most separation devices are likely to be filled only once, the locking piece allows either filling further material into the separation chamber (e.g. in case material has been disappeared from the separation chamber or voids have been formed, for example under the influence of pressure variations), but also to refill the separation device with the same or a different stationary phase material. The locking piece may further separate the separation chamber from any kind of filling apparatus or device coupled to the locking piece.

The separation device can be any suitable device providing a stationary phase, which then in combination with a mobile phase allows separating compounds of a sample fluid. For example, the separation device can be or comprise a chromatographic column, e.g. in conventional tube type form or as or in a microfluidic chip or application, a separation capillary in a capillary electrophoresis (CE) application, etc.

The locking piece allows maintaining a filling pressure applied on the stationary phase in the separation chamber even after filling (when being in the second position), in case such applied filling pressure has been maintained during moving the filling channel from the first into the second position. As filling pressure it is usually understood the differential pressure between the inlet and the outlet of the separation chamber during filling. Such filling pressure might be up to 2000 bar. Typically, the filling pressure in microfluidic applications is the range of a few bar and up to 10 bar, for analytical columns (usually conventional tube type columns) as well as metal planar structures about 1500 bar and up to 2000 bar, and for capillary electrophoresis (CE) applications about 10 bar. In this respect, it is to be understood that the term “maintaining filling pressure” shall also cover maintaining a pressure on the stationary phase in the separation chamber which is lower than the pressure applied to the stationary phase during filling. For example, the stationary phase might be filled in at a pressure of 1500 bar, and—after filling—pressure on the stationary phase is “maintained only” at 1200 bar. Maintaining a higher filling pressure (e.g. in the range as during filling) might be useful for pre-compression of the stationary phase in the separation chamber. Maintaining a smaller (filling) pressure, (e.g. in a range substantially lower than during filling) e.g. in the range of 1-100 bar, preferably about 10 bar, even after filling can be of advantage e.g. to avoid or reduce degassing of the mobile phase.

By moving the opening of the filling channel substantially laterally with respect to the housing, a void volume remaining from where the filling channel was penetrating into the separation chamber during the first position can be reduced or even be avoided. Laterally moving the opening of the filling channel can significantly reduce formation of such void volumes in contrast to the aforementioned GB 2440244 A, wherein the “filling channel” is penetrating axially into the separation chamber thus leaving an immense void volume in the packed separation channel, which renders such separation device unsuitable for high performance separations.

In one embodiment, the locking piece is configured to move the opening of the filling channel substantially tangentially with respect to the housing. The term “tangentially moving” shall cover any kind of movement which is substantially following a shaping of the housing at the position, where the filling channel opens into the separation chamber, or—in other words—any kind of movement that substantially follows the direction of the housing at the position, where the filling channel opens into the separation chamber. It is clear that the term “tangentially” is not limited in a pure mathematical sense to a straight line that touches a curve at a given point or, correspondingly, to a plane that touches a surface at a given point.

In case of a circular or elliptical shape of (the part of) the housing where the filling channel opens into the separation chamber, e.g. along an axial side of a tubing, the term “tangentially moving” shall cover e.g. a rotational or translatory movement, so that a “plane of the opening”, e.g. the cutting plane where the filling channel cuts the housing of the separation, is moved (between the first and second positions) in a straight tangent or slight secant (e.g. less than 10% of the diameter of the circular or elliptical shape of the housing) to the housing. A rotational movement can be substantially concentric to the shape of the housing or in an axis substantially parallel to an axis of the housing. In the latter case, a plane of the resulting circular or elliptical movement of the opening may either touches or slightly cut the housing where the filling channel opens into the separation chamber. A translatory movement can be in the tangent plane to the shape of the housing or slightly cutting the housing where the filling channel opens into the separation chamber.

In case of a substantially planar shape of (the part of) the housing where the filling channel opens into the separation chamber, e.g. along an radial side of a tubing, the term “tangentially moving” shall cover e.g. a rotational or translatory movement, so that a “plane of the opening”, e.g. the cutting plane where the filling channel cuts the housing of the separation, is moved (between the first and second positions) in a straight tangent or slight secant (e.g. less than 10% of the diameter of the circular or elliptical shape of the housing) to the housing. In a rotational movement a plane of the resulting circular or elliptical movement of the opening may either touches or slightly cut the housing where the filling channel opens into the separation chamber. A translatory movement can be in a plane substantially parallel to the planar shape of the housing, and may even slightly cut into housing.

In one embodiment, the separation device comprises a first port for receiving a mobile phase and a second port for outletting the mobile phase after passing the separation device. In such embodiment, the filling port might be physically separated from the first and second ports, thus providing a third port, which might be located on either side of a housing of the separation chamber, for example along a direction of the mobile phase flowing through the separation device or perpendicular thereto. Alternatively or in addition thereto, one of the first and second ports might be decoupled from the separation chamber in the first position, and might then be coupled to the separation chamber, when the locking piece is moved into the second position. This can be provided by the locking piece, so that in the first position only one of the first and second ports are coupled to the separation chamber, while the other is decoupled from the separation chamber. Preferably by moving the locking piece from the first into the second position, the locking piece also couples the former decoupled port to the separation chamber, so that in the second position both the first and second ports are now coupled to the separation chamber. In other words, the locking piece might “exchange” the filling channel against one of the first and second ports when moving the locking piece from the first to the second position.

In one embodiment, the separation device comprises the first port at a first end for receiving a mobile phase, and at a second end opposing the first end, the second port for outletting the mobile phase. In the first position the filling channel is coupled to the separation chamber either at the first end, the second end, or a wall of the housing between the first and second ends.

In one embodiment, the locking piece comprises a fluid port which opens into the separation chamber, when the locking piece is moved into the second position. In this embodiment, the locking piece “exchanges” the filling channel with a fluid port when moving from the first into the second position.

In case the filling channel is coupling to a wall of the housing between the first and second ports, the effective cross section for pushing the stationary phase into the separation chamber is doubled, as long as the stationary phase can flow to either side of the filling channel into the separation chamber. Accordingly, flow resistance is only half with respect to a filling from an end side of the separation chamber. Further in case the filling channel couples at the wall of the housing, only a reduced length of the separation device has to be filled with respect to a coupling to an end of the housing. In case the filling channel couples substantially in the middle between both ends, the effective cross section for filling is substantially twice of the cross section of the separation chamber during the entire filling process, and only half of the filling length with respect to filling from an end side. Accordingly the pressure drop along the separation chamber can thus be reduced, which may allow filling the separation device with a higher packing density at the same filling pressure with respect to filling from the end side of the separation device.

The fluid port may comprise a filter element, which may be a frit, a mesh (often also referred to as disk or sieve) or a combination of both. The fluid port may be one of the first and second ports. The locking piece may also rotate the filling channel and the fluid port around an axis which is substantially parallel to an axis of flow of the mobile phase flowing through the separation device.

By adequately designing the locking piece, a filling pressure applied during filling on the stationary phase can be maintained within the separation chamber when the locking piece is moved into the second position.

The locking piece is preferably configured and designed to provide a relative movement for moving the filling channel from the first into the second position (and return). Such relative movement, which might be a translational motion, rotary motion, or a combination thereof, may be provided by one or more moveable components and one or more stationary (non-moveable) components of the locking piece. In other words, one or more moveable components might be moved against each other, thus providing the relative movement, or one or more components might be moved with respect to one or more stationary components, thus also providing the relative movement.

In one embodiment, a securing piece is provided for securing the locking piece in at least one of the first and second positions. Thus, it can be ensured that the locking piece is fixed in either one or both (first and second) positions and secured against (intentional or non-intentional) change of the position. Preferably, the securing piece at least secures the locking piece to remain in the second position, thus ensuring that the locking piece does not provide a source of leakage or that any material might escape from the separation device through the filling channel. This also allows making sure that any filling pressure is at least substantially maintained in the separation device. The securing piece might be a clamp connection, a locking pin, a cone pin, a screw, a screw nut, a combination thereof, or any other adequate locking mechanism as known in the art. Alternatively, the locking piece may be secured by an irreconcilable bonding technique e.g. using welding, brazing or soldering processes.

In one embodiment, the locking piece comprises a rotary piece for achieving a rotary motion of the filling channel. The rotary piece comprises the filling channel and is configured to rotate the filling channel, so that the filling channel is opening with one end into the separation chamber in the first position. Rotating the rotary piece allows separating the opening of the filling channel from the separation chamber and thus locking the separation chamber against the filling channel in the second position.

The rotary piece might preferably comprise a closing surface which seals the separation chamber in the second position. In other words the closing surface is configured to seal the separation chamber against the locking piece, e.g. in the second position or already when the locking piece is moved into the second position. The closing surface might preferably be provided by a segment of a circle of the rotary piece, which is rotated towards the separation chamber or even (partly) into the separation chamber, so that the closing surface penetrates at least partly into the separation chamber. This allows to limit or even avoid a dead volume caused by the transition from the first to the second position. Dead volume is usually understood as any kind of volume not being functionally required. Rotating the closing surface at least partly into the separation chamber reduces the volume within the separation chamber available for the stationary phase with respect to the condition in the first position (when the filling channel is coupled to the separation chamber). Reducing the volume within the separation device, however, might also change the flow conditions within the separation device, reduce an effective cross section of the separation device, and increase flow resistance of the separation device. Accordingly, adequately designing the rotary piece might thus decrease such volume reduction. This might already be achieved by increasing the rotary cross section of the rotary piece.

In order to limit adverse effects on the performance of the separation device, the shape of the separation chamber should be influenced (by the locking piece) as less as possible. Such adverse effects may result from a reduction of the effective cross section of the separation chamber. Also or further, a void volume and/or compression of the stationary phase material may be caused as result of the movement of the locking piece. Such adverse effects may be reduced or even be avoided by providing the shape of the rotary piece shaped matching as close as possible to the shape of the separation chamber (at least in the area where the rotary piece meets the separation chamber). In case, for example, the separation chamber has a convex shape, the rotary piece should preferably also have such convex shape, at least where the rotary piece meets the separation chamber. In one embodiment, the locking piece comprises a shifting piece in order to provide a translational motion of the locking piece. The shifting piece comprises the filling channel and is configured to shift the filling channel, so that the filling channel is opening with one end into the separation chamber in the first position. Shifting the shifting piece allows separating the opening of the filling channel from the separation chamber and thus locking the separation chamber against the filling channel in the second position. The shifting piece might comprise a closing surface sealing the separation chamber against the locking piece, when the locking piece is moved into the second position.

In embodiments, the separation chamber is provided by a tube, which might have at least a section with a cross section being substantially round, oval, elliptical or rectangular. While preferably the tube is provided having a continuous cross sectional shape and/or a continuous and uniform cross section, embodiments might comprise variations and combinations of different cross sectional shapes and sizes.

In one embodiment, the separation device is embodied in a microfluidic device having a microfluidic channel in a substrate (which substrate might be a glass, ceramic, metal, plastic, etc. material or a combination thereof). The separation device might be provided as a section of the microfluidic channel, as disclosed by the applicant e.g. in U.S. Pat. No. 5,500,071 A or EP 1577012 A1, which teaching with respect to microfluidic column devices shall be incorporated herein by reference.

In one embodiment, the separation device is embodied as a separation capillary to be used in a CE application, as disclosed e.g. in U.S. Pat. No. 5,858,241 A or on WWw.chem.agilent.com with respect to the Agilent Capillary Electrophoresis System, both by the same applicant. The teaching thereof shall be incorporated herein by reference.

One embodiment comprises an apparatus for filling the separation device with the stationary phase. The apparatus comprises a filling port configured for filling the stationary phase into the separation chamber, which filling port comprises a locking piece having a filling channel from the first to the second position in accordance with the above said. In such embodiment, the filling port with the locking piece might be part of the separation device (as in the previous embodiments) or separated therefrom.

The apparatus might further comprise a container comprising the stationary phase to be filled into the separation chamber. Further or alternatively, the apparatus might comprise a filling adapter and/or a coupling channel, each being configured to couple, at least in the first position, between the filling channel and the container with the stationary phase. Embodiments might further or alternatively comprise a filling pump for moving the stationary phase into the separation chamber. A mixer might be provided for mixing the stationary phase with a filling fluid.

In one embodiment, the separation device is comprised in a fluid separation system, which is provided for separating compounds of a sample fluid in a mobile phase. The fluid separation system comprises a mobile phase drive, such as pumping system, configured to drive the mobile phase through the fluid separation system. The separation device is provided for separating compounds of the sample fluid in the mobile phase. The fluid separation system might further comprise one or more of the following: a sample injector to introduce the sample fluid into the mobile phase, a detector to detect separated compounds, a collection unit to collect separated compounds, a data processing unit processed data received from the fluid separation system, and a degassing apparatus for degassing the mobile phase before being provided to the separation device.

In a method according to the disclosed embodiments for filling a separation device with a separation chamber for housing the stationary phase, the method comprises filling the stationary phase through a filling channel into the separation chamber, and moving the filling channel from the first to the second position in accordance with the afore said.

Certain embodiments might be based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

One embodiment comprises a pumping apparatus having a piston for reciprocation in a pump working chamber to compress liquid in the pump working chamber to a high pressure at which compressibility of the liquid becomes noticeable.

The separating device preferably comprises a chromatographic column providing the stationary phase. The column might be a glass or steel tube (e.g. with a diameter from 50 μm to 5 mm and a length of 1 cm to 1 m) or a microfluidic column (as disclosed e.g. in the aforementioned in U.S. Pat. No. 5,500,071 A or EP 1577012 A1 or the Agilent 1200 Series HPLC-Chip/MS System provided by the applicant Agilent Technologies, see e.g. http://www.chem.agilent.com/Scripts/PDS.asp?IPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the Agilent 1200 Series Rapid Resolution LC system or the Agilent 1100 HPLC series, both provided by the applicant Agilent Technologies, under www.aqilent.com which shall be in cooperated herein by reference.

Certain embodiments can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of the disclosed embodiments will be readily appreciated and become better understood by reference to the following more detailed description of embodiments in connection with the accompanied drawing(s). Features that are substantially or functionally equal or similar will be referred to by the same reference sign(s).

FIG. 1 shows a liquid separation system 10, in accordance with the disclosed embodiments, e.g. used in high performance liquid chromatography (HPLC).

FIG. 2 illustrates a typical embodiment of a chromatographic column 30 as separation device.

FIGS. 3-7 illustrate different embodiments, with FIGS. 3A-F depicting a first embodiment,

FIGS. 4A-E a second embodiment,

FIGS. 5A-E a third embodiment, and

FIGS. 6A-B showing a forth embodiment of a rotary type locking piece, and

FIGS. 7A-B depicting an embodiment of a translatory type locking piece, each in different views.

### DETAILED DESCRIPTION

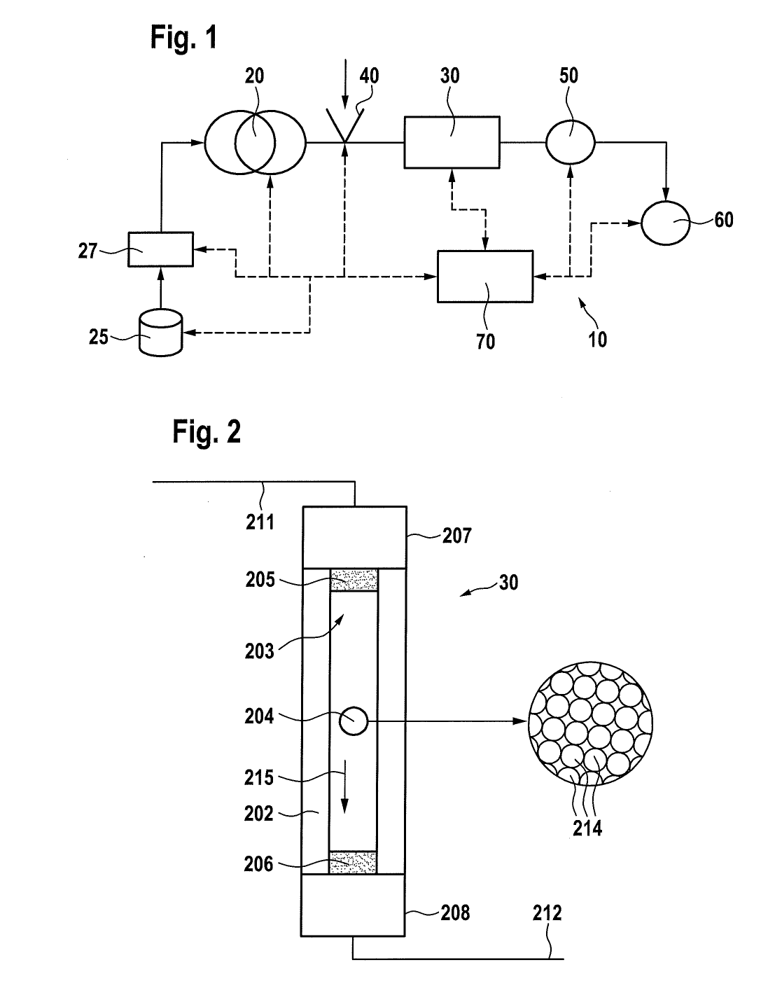

Referring now in greater detail to the drawings, FIG. 1 depicts a general schematic of a liquid separation system 10. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is configured for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

FIG. 2 illustrates a typical embodiment of a chromatographic column 30 as separation device. The column 30 comprises a housing 202 which—in this exemplary embodiment—is shaped as a hollow cylinder or tube. Within the housing 202, a column chamber as a separation chamber 203 is defined (in case of a tube shape or hollow bore, the separation chamber 203 provides a tubular reception), which is or is to be filled with a stationary phase 204, such as a package material or package composition. The column 30 further comprises a first filter element 205 close to an inlet port 207 of the column 30 and a second filter element 206 provided at an outlet port 208 of the column 30. Each of the filter elements 205 and 206 are provided to retain the package composition 204 within the separation chamber 203 of the column tube 202 and may be embodied by a frit, a mesh or a combination thereof, as readily known in the art. Adequate fitting elements (for coupling elements such as connectors, conduits, capillaries, etc.) might be attached to or provided by one or both of the first and second ports 207 and 208.

A flowing direction of the mobile phase through the column 30 is denoted with reference numeral 209. The column 30 receives the mobile phase (e.g. from the pump 20 of FIG. 1) for example through a connection tube 211, e.g. a capillary (e.g. a metal capillary), and from there through the inlet port 207 and the first frit 205 into the separation chamber 203. Within the separation chamber 203, the mobile phase interacts with the stationary phase 204, and different compounds of a sample fluid introduced into the mobile phase may thus be separated. After having left the separation chamber 203, that is to say after having passed the second filter element 206 and the outlet port 208, a second tube or pipe 212 (e.g. a capillary such as a metal capillary) transports the mobile phase (including the separated compounds). A typical packing composition 204 may comprise a plurality of silica gel beads 214, as schematically indicated in FIG. 2, which may be packed under pressure into the separation chamber 203 of the column tube 202.

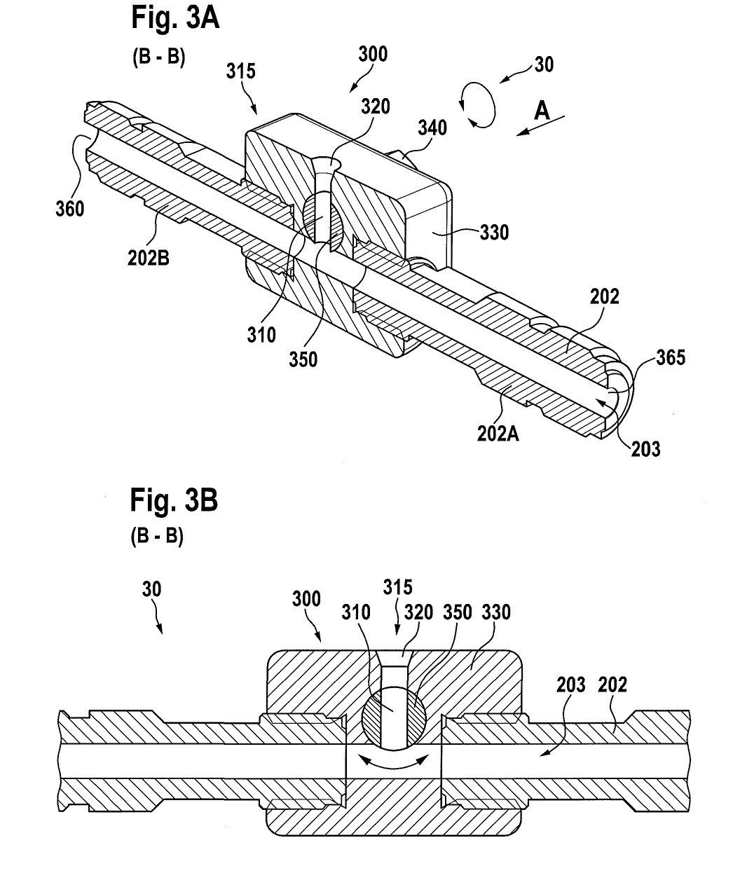

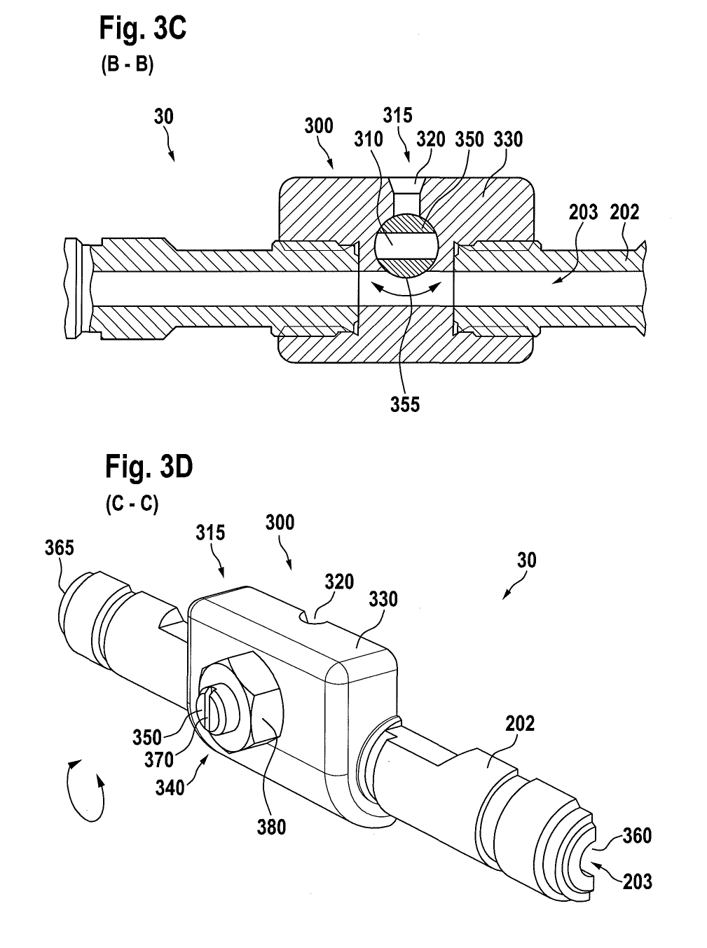

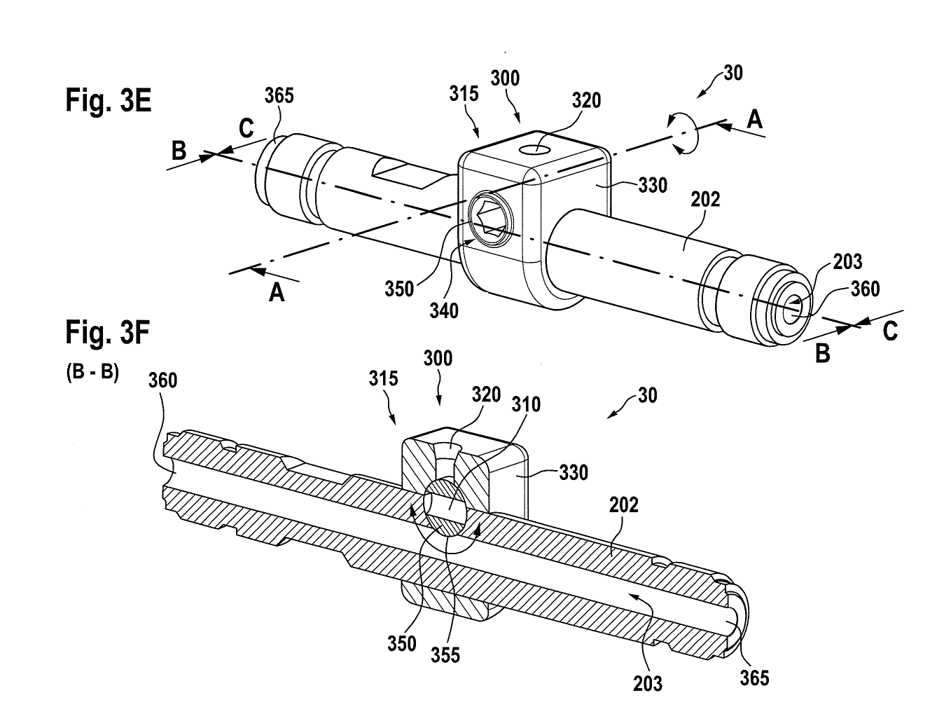

FIG. 3A shows in a three dimensional, cross-sectional view a first embodiment of a chromatographic column 30, as seen along cutting line B-B as depicted in FIG. 3E. It is noted that FIGS. 3A-D and FIGS. 3E-F each show slightly different variants, but otherwise fully correspond with each other. As only FIG. 3E shows a full three-dimensional view, all cutting lines as referred to in FIG. 3 correspond to the view as depicted in FIG. 3E.

In FIG. 3A, the column 30 has a housing 202 providing a separation chamber 203 (representing a tubular reception in the embodiment of FIG. 3) for receiving the stationary phase. For the sake of simplicity, the embodiments of the FIGS. 3-7 are depicted without stationary phase.

The column 30 further comprises a locking piece 300 having a filling channel 310, which in a first position as shown in FIG. 3A is opening with one end into the separation chamber 203, thus allowing to fill stationary phase material into the separation chamber 202. The other side of the filling channel 310, opposite to the side opening into the separation chamber 203, opens towards a coupling channel 320, which allows coupling the filling channel 310, for example with a container comprising the stationary phase 204, as will be shown later in FIG. 8. The locking piece 300 together with the filling channel 310 provides a filling port 315 configured for filling the stationary phase 204 through the filling channel 310 into the separation chamber 203.

The locking piece 300 further comprises a body 330, which houses the filling channel 310 as well as a rotational mechanism 340 for rotating the filling channel 310, as will be better seen in the following FIGS. 3B-D. In this embodiment, the filling channel 310 is provided by an opening in a shaft 350, which is part of the rotational mechanism 340. The opening providing the filling channel 310 might be a bore or the like. The rotational mechanism 340 allows rotating the shaft 350 (around an axis as indicated by the curved arrow in FIG. 3), so that the opening of the filling channel 310 is moved substantially tangentially with respect to the shape of the housing 202.

FIGS. 3B and 3C correspond to the view of FIG. 3A, however in a two-dimensional cross-sectional view. While FIG. 3B shows the same view as in FIG. 3A, i.e. with the shaft 350 in the same first position, the shaft 350 has been rotated (by about 90°, or 270° correspondingly), so that the filling channel 310 does not open anymore into the separation chamber 202. In this second position, the separation chamber 203 is locked against the filling channel 310, so that on one hand no (further) stationary phase material 204 can be filled into the separation chamber 203, and—on the other hand—a pressure on the stationary phase 204 (in the separation chamber 203) as applied during filling into the separation chamber 203 can be maintained even after filling.

While the columns 30 in FIG. 3 are depicted with open ends of the separation chamber 203, it is clear that filling of the column 30 is usually provided in a closed fashion, so that the two ends 360 and 365 of the separation chamber 203 are adequately closed. This is typically provided as shown in FIG. 2 with the sides 360 and 365 being closed by the filter elements 205 and 206 together with adequate fitting elements to provide the ports 207 and 208, as well known in the art.

Further in FIG. 3C, when the shaft 350 is rotated to lock the separation chamber 202 against the filling channel 310, the shaft 350—as far reaching into the separation chamber 203—provides a closing surface 355, which seals the separation chamber 203 against the locking piece 300. The shaft 350 and/or the closing surface 155 are/is preferably shaped matching as close as possible to the shape of the separation chamber 203 (at least in the area where the rotary piece meets the separation chamber). In the examples of FIG. 3, where the separation chamber 203 has a convex shape, the shaft 350 and/or the closing surface 155 should preferably also have such convex shape, at least where meeting the separation chamber 203.

FIG. 3D shows the same three dimensional, cross-sectional view as in FIG. 3A, however, as seen from arrow A in FIG. 3A-or cutting line C-C as depicted in FIG. 3E. In this view, in particular the rotational mechanism 340 together with the shaft 350 become better visible. The shaft 350 is provided with a slot 370, which allows engaging with and thus rotating the shaft 350, for example, by using a screw driver or the like. A screw nut 380 might be provided to secure the position of the shaft 350. It is clear that any other mechanism for rotating and/or securing the shaft 350 can applied accordingly, such as caulking, pressing-in, gluing, using any kind of adhesive, welding, etc.

FIG. 3E shows in a full three-dimensional view a slightly different variant from the embodiments of FIGS. 3A-D and otherwise corresponds to the view as shown in FIG. 3D. The embodiment of FIGS. 3D-E mainly differs from the embodiment of FIG. 3A-D by showing a different rotational mechanism 340.

The housing 202 in FIGS. 3A-D is provided by two individual housing pieces 202A and 202B (see FIG. 3A), which might be fixed to or with the locking piece 315 in any suitable way such as screw fitting, etc., The housing 202 in the embodiments of FIG. 3E-F is provided as in integral piece with the locking piece being attached (in any suitable way) to the outer surface of the housing 202.

FIG. 3F shows the embodiment of FIG. 3E however shown in cross-sectional view corresponding to FIG. 3A, however with the difference that FIG. 3A shows the first position and FIG. 3F depicts the second position (of the filling channel 310). In this second position as depicted in FIG. 3F, the shaft 350 provides the closing surface 355, which seals the separation chamber 203 against the locking piece 300.

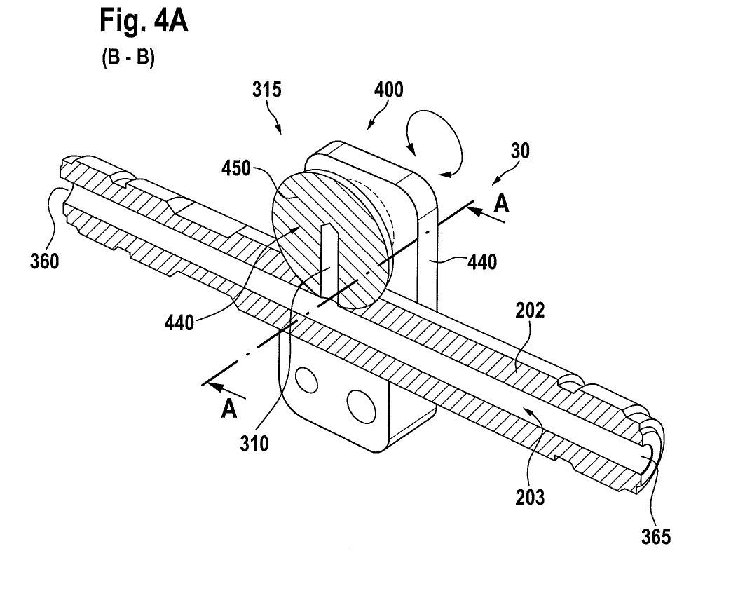

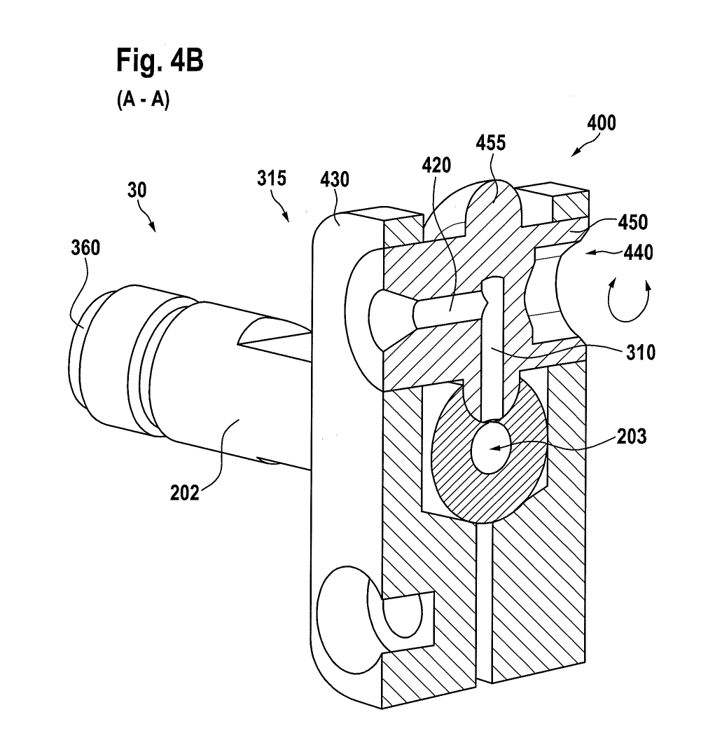

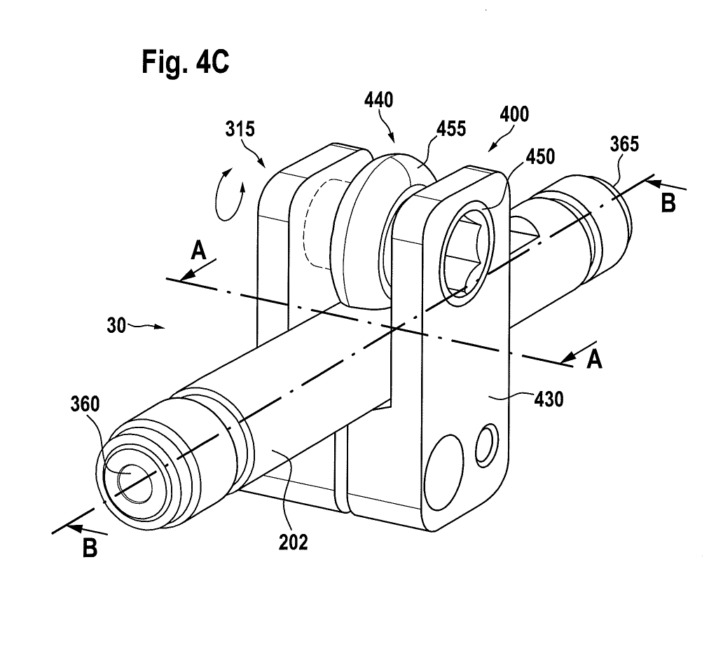

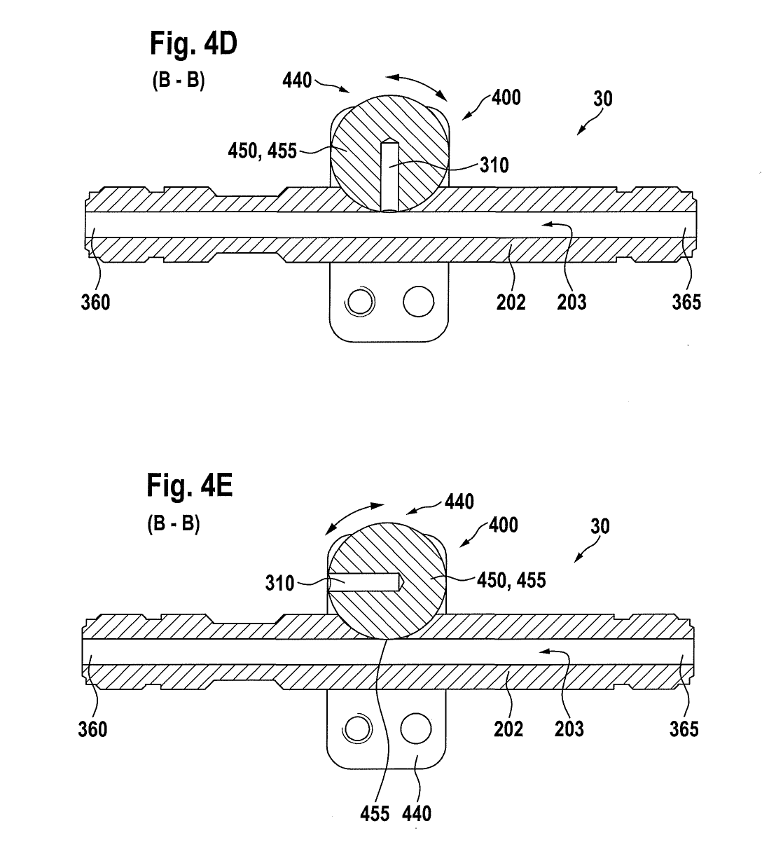

FIGS. 4A-4E illustrate a second embodiment of the column 30. In FIG. 4, the filling port 315 has a different locking piece 400 than the locking piece 300 of FIG. 3. Whereas the coupling channel 320 in FIG. 3 substantially extends in the same direction as the filling channel 310 when coupling to the separation chamber 203 (see FIG. 3A), the locking piece 400 in FIG. 4 comprises a coupling channel 420 extending in a different direction than the filling channel 310. In the example of FIG. 4 and which can be seen best in FIG. 4B, the coupling channel 420 extends substantially perpendicular to the filling channel 310.

FIG. 4A shows a two-dimensional, cross-sectional view, which depicts the locking piece 400 in the first position (opening into the separation chamber 203), corresponding to the view and the aforesaid with respect to FIG. 3A. The view in FIG. 4A is shown along cutting line B-B, as can be best seen in the three-dimensional view of FIG. 4C. FIG. 4B shows a three-dimensional cross-sectional view along cutting line A-A of FIG. 4C.

In accordance with the embodiment of FIG. 3, the locking piece 400 in FIG. 4 comprises a rotational mechanism 440 allowing rotating a shaft 450 around an axis as indicated by the curved arrow in FIG. 4, and the opening of the filling channel 310 is also moved substantially tangentially with respect to the shape of the housing 202. The rotational axis of each of the locking pieces 300, 400 in FIGS. 3 and 4 (perpendicular to the drawing plane) is substantially perpendicular to an axis of the tubular shaped housing 202 (in or parallel to the drawing plane). Alternatively (but now shown in the figures), the rotational axis of each of the locking pieces 300, 400 may also be in the drawing plane of FIGS. 3 and 4 is substantially parallel (but shifted to) the axis of the tubular shaped housing 202.

Fitted to the shaft 450 is a flange 455. The shaft 450 together with the flange 455 house and provide the filling channel 310. When the filling channel 310 is separated from the separation chamber 203, for example as depicted in FIG. 4E, the shaft 450 closes and seals the separation chamber 203 with a sealing surface 455.

The flange 255 can be moved from the filling position to the locking position, and vice verso, by moving the internal hex of the shaft 450. The body 430 might be comprised of two halves (as depicted in the FIGS. 4B-C) bearing the shaft 450 with the flange 455. The two halves might be fixed together using a screw fitting or any other suitable means.

FIGS. 4D and 4E illustrate the locking piece 400 in a two-dimensional cross sectional view along the line B-B of FIG. 4C. FIG. 4D shows the first position wherein the filling channel 310 is coupled with the separation chamber 203, thus allowing filling the stationary phase 204 into the separation chamber 203. By rotating the shaft 450 together with the flange 455 as indicated by the curved arrow, the locking piece 400 can be moved into the second position, wherein the separation chamber 230 is locked against the filling channel 310.

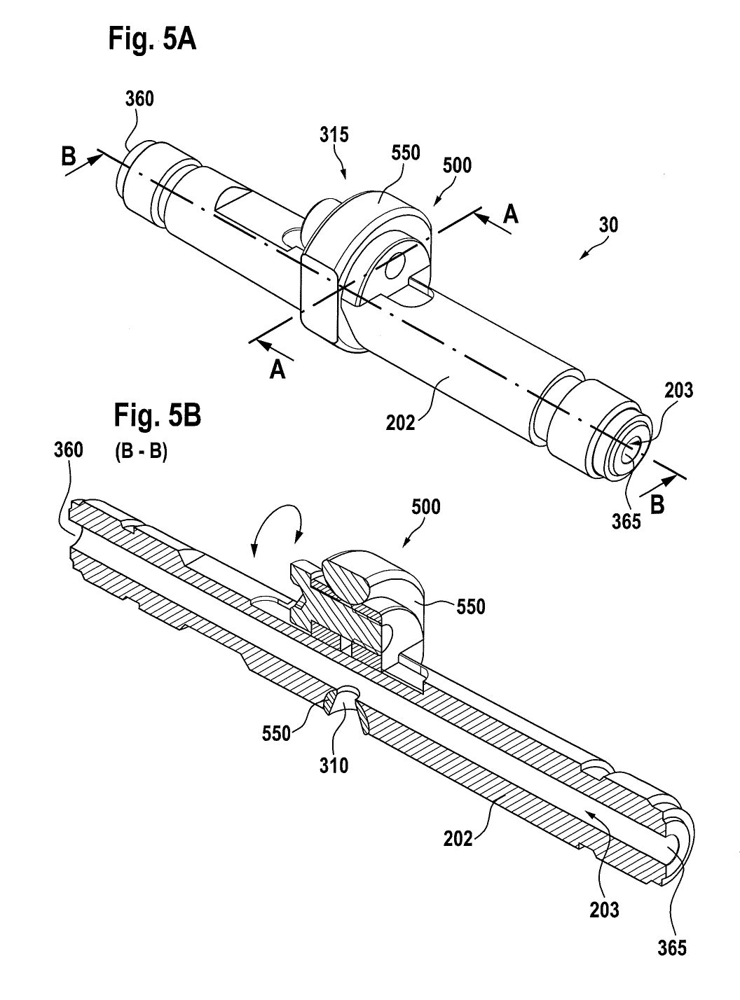

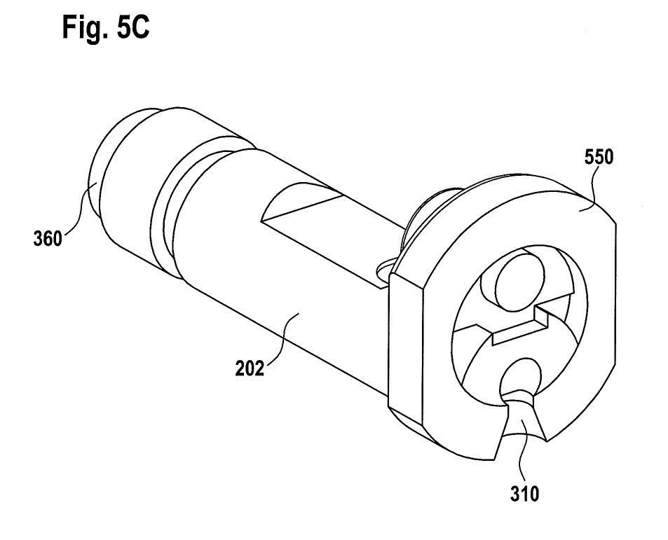

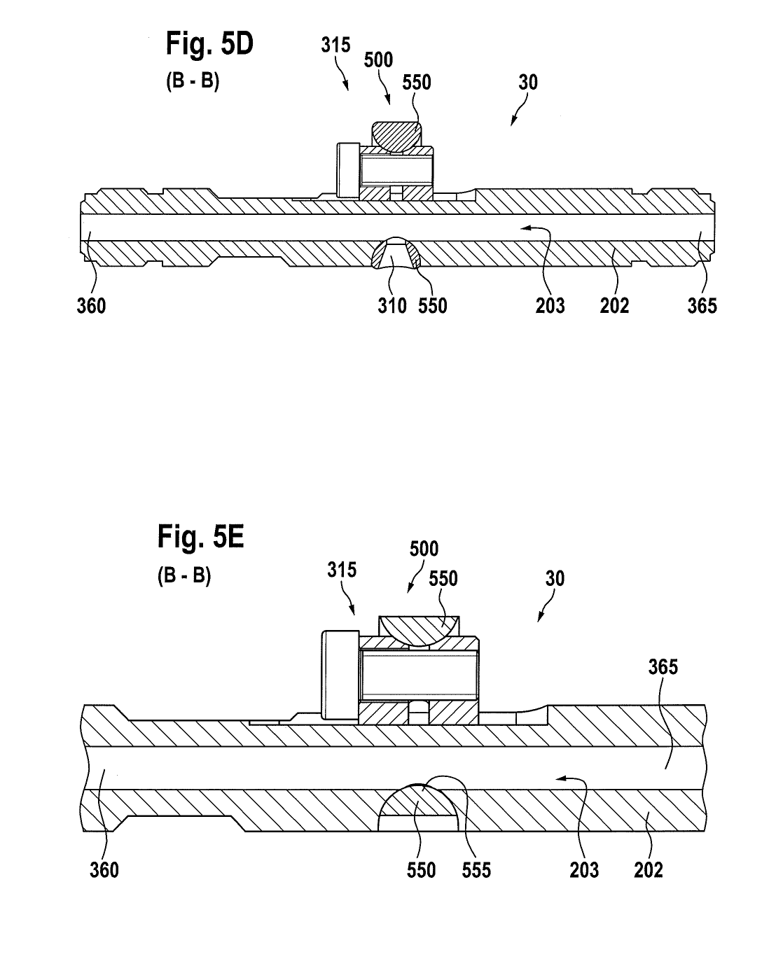

FIGS. 5A-5E show a third embodiment of the column 30 having a different locking piece 500 than in the embodiments of FIGS. 3 and 4. FIG. 5A shows the embodiment in three-dimensional view, while FIGS. 5B and 5C show different three-dimensional cross-sectional views, with FIG. 5B showing the view along cutting line B-B and FIG. 5C along cutting line A-A of. FIG. 5A. FIGS. 5D and 5E show two-dimensional cross sectional views along the cutting line B-B in FIG. 5A.

As best be seen in FIG. 5B, the locking piece 500 comprises a ring 550 which can be rotated, as indicated by the curved arrow in FIG. 5, around an axis substantially parallel to an axis of the separation chamber 203, and the opening of the filling channel 310 is moved substantially tangentially with respect to the shape of the housing 202. The filling channel 310 is provided within the ring 550 and can be rotated into the first position, as seen in FIGS. 5B and 5D, wherein the filling channel 310 opens into the separation chamber 203. E.g. after filling, the ring 550 can be rotated in order to remove the filling channel 310 from the separation chamber 203 into the second position as shown in FIG. 5E. In the second position, as shown in FIG. 5E, the ring 550 provides a sealing surface 555 towards the separation chamber 203.

For assembling, the ring 550 can be placed over the housing 202 and into a groove for receiving the ring 550 (see FIG. 5D). The ring 550 may be provided with a conical bore and having two locking surfaces used for rotating the ring 550 relative to the housing 202. The ring 550 might be sealed against the housing 202 by applying pressure onto the ring, This might be achieved, for example, by pressing two conically shaped clamping pieces from opposing sides into the ring 550 and affixing the clamping pieces against each other e.g. by screw fitting. Thus, the ring 550 is pressed and fixed against the separation chamber.

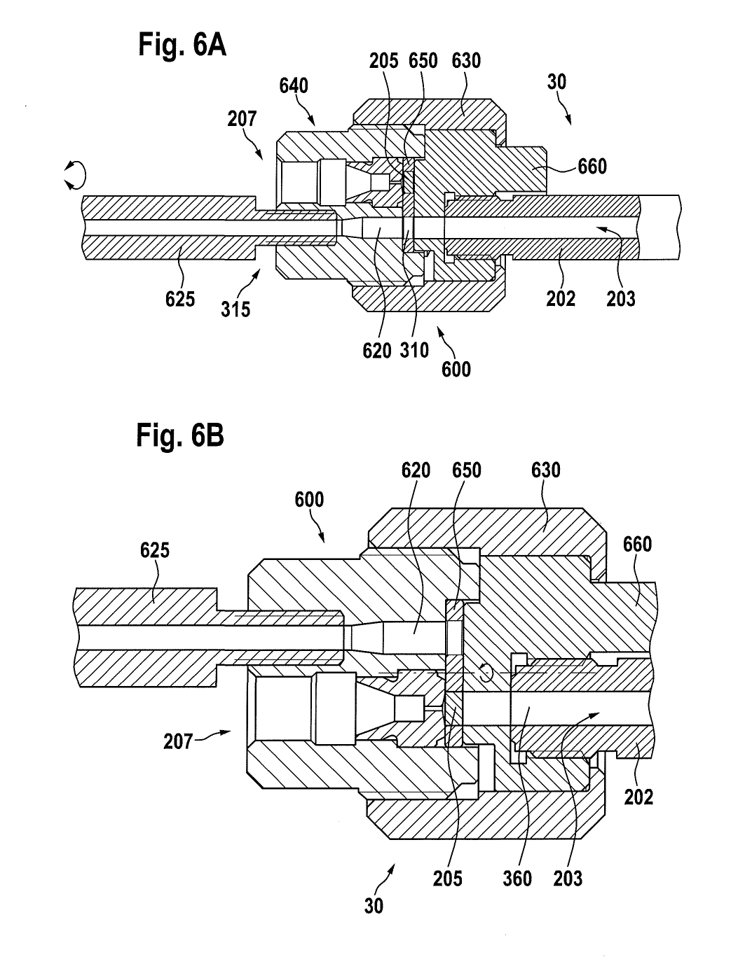

FIGS. 6A and 6B show a fourth embodiment, wherein the column 30 comprises a locking piece 600, which also uses a rotational movement as in the embodiments of FIGS. 3-5. However, while in the embodiments of FIGS. 3-5 the filling port 315 was located at a (substantially tubular) side wall of the housing 202 and thus physically separated from the first and second ports 360 and 365 used for introducing and removing the mobile phase during use of the column 30, the locking piece 600 in FIG. 6 is located at a (substantially planar) end wall of the (substantially tubular) housing 202 and configured to replace the filling port 315 with the first port 207, for example after filling the separation chamber 203. Accordingly, the column 30 in FIG. 6 will always have only two ports coupling towards the separation chamber 203 in the first position as well as in the second position.

FIG. 6A illustrates the first position allowing to fill the separation chamber 203 with the stationary phase 204. The filling channel 310 is opening on one side towards the separation chamber 203 and on the other side towards a coupling channel 620. A connector 625, which might be a capillary or other kind of tubing, is coupling to the coupling channel 620 and might further be connected for filling the column 30 (as shown later in FIG. 8). A housing 630 houses the filling port 315 together with a rotational mechanism 640 having a seal 650. The rotational mechanism 640 can be rotated as indicated by the curved arrow, and the opening of the filling channel 310 is also moved substantially parallel (as the extreme case to tangential movement) with respect to the substantially planar shape at the axial end of the housing 202. This removes the filling port 315 together with the coupling channel 310 from opening towards the separation chamber 203 and replaces the filling channel 315 against the first port 207, which is then used for introducing the mobile phase into the separation chamber 203 during use. It is clear, however, that instead of the first port 207 also the second port 208 used for outletting the mobile phase can be used accordingly.

FIG. 6B depicts the second position, wherein the first port 207 is coupling and opening towards the separation chamber 203. As also shown in FIG. 2, the first port 207 comprises the filter element 205 for retaining the stationary phase 204 in the separation chamber 203 after filling. As can be seen from FIGS. 6A and 6B, the locking piece 600 is attached to the housing 202 at the first end 360 by using a column holder 660. The frit 205 is pressed in a disc 650 (e.g. embodied using a PEEK material) and inserted into the rotational mechanism 640, so that the disc 640 cannot be rotated against the rotational mechanism 640. Preferably, the disc 650 is rectangular shaped and inserted into a correspondingly shaped recess/shoulder of the rotational mechanism 640. The rotational mechanism 640 is affixed pressure tight against the column holder 660 e.g. by using a coupling nut of the housing 630. The coupling nut, the rotational mechanism 640, and the disc 650 can then be rotated relative to the column holder 660, e.g. by about 180 degrees. The preload force as provided by the coupling nut might also be generated by using an adequate spring mechanism, such as a set of springs, disc springs, etc.

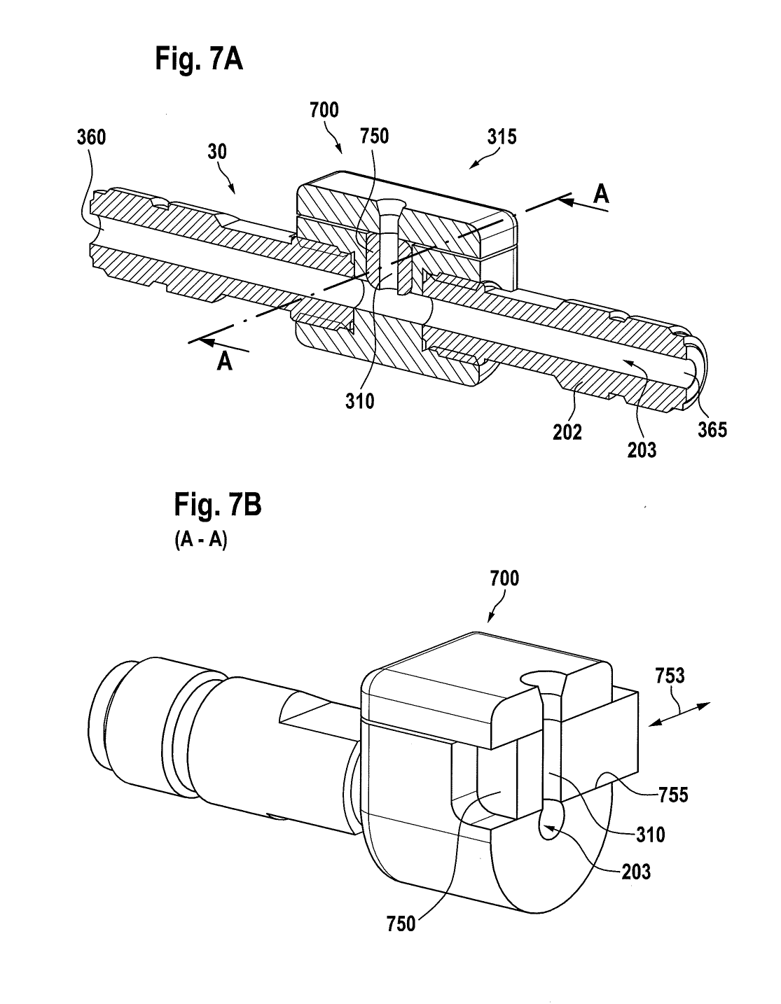

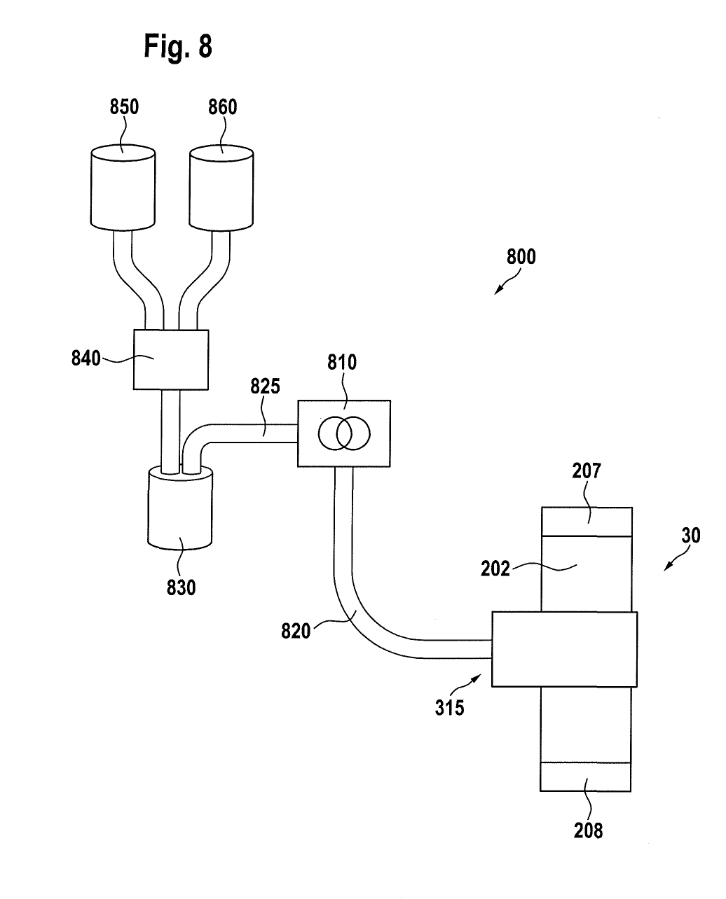

FIGS. 7A and 7B show an embodiment using a shifting mechanism in contrast to the rotational mechanisms of the embodiments of FIGS. 3-6. The three-dimensional, cross sectional view in FIG. 7A substantially represents the view as seen in FIG. 3A. However, while the locking piece 300 in FIG. 3A comprises the shift 350, which allows rotating the filling channel 310 to open or lock against the column 203, the filling channel 310 in FIG. 7A comprises a locking piece 700 having a shifting element 750 which comprises the filling channel 310.

FIG. 7B shows a three-dimensional, cross sectional view along the cutting line A-A of FIG. 7A, however, being otherwise closed in contrast to the view in FIG. 7A. A horizontal arrow 753 illustrates the shifting direction to be applied to the shifting element 750, which moves the opening of the filling channel 310 substantially tangentially with respect to the substantially tubular shape of the housing 202. In the representation of both FIGS. 7A and 7B, the filling channel 310 is opening towards the separation chamber 203, thus allowing to fill stationary phase into the separation chamber 203. However, by shifting the shifting element 750 in either direction of the arrow 753 will lock the separation chamber 203 against the filling channel 310. The separation chamber 203 is then sealed by a sealing surface 755.

FIG. 8 shows in a schematic representation an embodiment 800 for filling the column 30. A filling pump 810 is coupled via a coupling channel 820 to filling port 315 for pumping the stationary phase 204 into the separation chamber 203. The filling pump 810 is further coupled by conduct 825 to a container 830 containing the stationary phase 204 to be filled into the column 203. A mixer 840 might further be used for mixing stationary phase material (indicated by reference numeral 850) with a filling fluid (indicated by reference numeral 860), which might then either be directly provided to the pump 810 or stored first in the container 830.

While FIG. 8 shows an embodiment wherein the filling port 315 is different from the first and second ports 207 and 208, it goes without saying that the filling port 350 may also coupled to one of the ends 360 and 365 of the separation chamber 203, for example as illustrated in FIG. 6.

1. A separation device comprising
a separation chamber having a housing for housing a stationary phase configured for separating compounds of a fluid sample,
a filling port configured for filling the stationary phase through a filling channel into the separation chamber, and
a locking piece comprising the filling channel and being configured to move the filling channel from a first position, wherein an opening of the filling channel is opening into the separation chamber for filling the stationary phase into the separation chamber, to a second position, wherein the separation chamber is locked against the filling channel,
wherein the locking piece is configured to move the opening of the filling channel substantially laterally with respect to the housing.

2. The separation device of claim 1, further comprising
the locking piece is configured to move the opening of the filling channel substantially tangentially with respect to the housing.

3. The separation device of claim 1, further comprising
a first port for receiving a mobile phase, and
a second port for outletting the mobile phase.

4. The separation device of claim 3, comprising at least one of:
the filling port is different from the first and second ports, so that the stationary phase can be filled only through the filling port into the separation chamber;
the filling port is different from the first and second ports, so that the stationary phase can be filled only through the filling port into the separation chamber;
the filling port is physically separated from the first and second ports;
one of the first and second ports is coupled to the separation chamber, when the locking piece is moved to the second position;
one of the first and second ports is coupled to the separation chamber by the locking piece, when the locking piece is moved to the second position.

5. The separation device of claim 1, wherein the separation device comprises at a first end a first port for receiving a mobile phase, and at a second end, opposing the first end, a second port for outletting the mobile phase, and in the first position the filling channel is coupled to the separation chamber at one of:
the first end,
the second end,
a wall of a housing of the separation chamber between the first and second ends.

6. The separation device of claim 1, wherein the locking piece comprises a fluid port opening into the separation chamber, when the locking piece is moved into in the second position.

7. The separation device of claim 6, comprising at least one of:
the fluid port comprises a filter element, preferably at least one of frit, disk, and mesh;
the fluid port is one of the first and second ports of claim 3;
the fluid port is one of the first and second ports of claim 4;
the locking piece rotates the filling channel and the fluid port around an axis being substantially parallel to an axis of flow of a mobile phase flowing through the separation device.

8. The separation device of claim 1, wherein a pressure applied on the stationary phase during filling into the separation chamber is substantially maintained when the locking piece is moved into the second position.

9. The separation device of claim 1, wherein the locking piece is configured to provide a relative movement for moving the filling channel from the first position to the second position.

10. The separation device of claim 9, wherein the relative movement is at least one of a translational motion and a rotary motion.

11. The separation device of claim 1, wherein the locking piece is configured to move the filling channel between the first and second positions.

12. The separation device of claim 1, further comprising a securing piece configured for securing the locking piece in at least one of the first and second positions.

13. The separation device of claim 1, wherein the locking piece comprises
a rotary piece comprising the filling channel and being configured to rotate the filling channel, so that the filling channel is opening with one end into the separation chamber in the first position, and rotating the rotary piece allows separating the opening of the filling channel from the separation chamber and thus locking the separation chamber against the filling channel in the second position.

14. The separation device of claim 13, wherein the rotary piece comprises a closing surface sealing the separation chamber against the locking piece, when moved into the second position.

15. The separation device of claim 14, wherein the closing surface is provided by a segment of a circle of the rotary piece rotated towards or into the separation chamber.

16. The separation device of claim 1, wherein the locking piece comprises
a shifting piece comprising the filling channel and being configured to shift the filling channel, so that the filling channel is opening with one end into the separation chamber in the first position, and shifting the shifting piece allows separating the opening of the filling channel from the separation chamber and thus locking the separation chamber against the filling channel in the second position.

17. The separation device of claim 16, wherein the shifting piece comprises a closing surface sealing the separation chamber against the locking piece, when moved into the second position.

18. The separation device of claim 1, comprising at least one of:
the separation chamber is provided by a tube;
the separation chamber is provided by a tube having at least a section with a cross-section substantially being one of: round, oval, elliptical, rectangular;
the separation chamber is provided by a channel of a microfluidic device;
the separation device is or comprises at least one of: a chromatographic column, a tube type chromatographic column, a microfluidic column chip, a separation capillary for capillary electrophoresis;
the fluid sample is comprised in a mobile phase.

19. The separation device of claim 1, wherein
in the first position, the filling channel is opening directly into the separation chamber.

20. The separation device of claim 19, wherein
in the first position, an opening of the filling channel is directly adjacent an opening into the separation chamber, so that the filling channel is opening directly into the separation chamber.

21. The separation device of claim 1, wherein
in the second position, wherein the separation chamber is locked fluid-tight against the filling channel.

22. An apparatus for filling a separation device with a stationary phase configured for separating compounds of a fluid sample, wherein the separation device comprises a separation chamber having a housing for housing the stationary phase, the apparatus comprising:
a filling port configured for filling the stationary phase into the separation chamber, wherein the filling port comprises a locking piece having a filling channel and being configured to move the filling channel from a first position, wherein an opening of the filling channel is opening into the separation chamber for filling the stationary phase into the separation chamber, to a second position, wherein the separation chamber is locked against the filling channel; wherein the locking piece is configured to move the opening of the filling channel substantially laterally with respect to the housing.

23. The apparatus of claim 22, comprising at least one of:
a container comprising the stationary phase to be filled into the separation chamber;
at least one of a filling adapter and a coupling channel, each being configured to couple, at least in the first position, between the filling channel and a container comprising the stationary phase to be filled into the separation chamber;
a filling pump configured for moving the stationary phase into the separation chamber;
a mixer for mixing the stationary phase with a filling fluid.

24. A fluid separation system for separating compounds of a sample fluid in a mobile phase, the fluid separation system comprising:
a mobile phase drive, preferably a pumping system, configured to drive the mobile phase through the fluid separation system;
a separation device, according to claim 1, configured for separating compounds of the sample fluid in the mobile phase.

25. The fluid separation system of claim 24, further comprising at least one of:
a sample injector configured to introduce the sample fluid into the mobile phase;
a detector configured to detect separated compounds of the sample fluid;
a collection unit configured to collect separated compounds of the sample fluid;
a data processing unit configured to process data received from the fluid separation system;
a degassing apparatus for degassing the mobile phase.
